(19) United States
(12) Patent Application Publication
(10) Pub. No.: US 2015/0091403 A1
(43) Pub. Date: Apr. 2, 2015

(54) TRANSVERSE FLUX MACHINE AND VEHICLE

(71) Applicant: KABUSHIKI KAISHA TOSHIBA, Tokyo (JP)

(72) Inventor: Yasuhito Ueda, Kanagawa-ken (JP)

(73) Assignee: KABUSHIKI KAISHA TOSHIBA, Tokyo (JP)

(21) Appl. No.: 14/291,681

(22) Filed: May 30, 2014

(30) Foreign Application Priority Data
Sep. 30, 2013 (JP) 2013-205870

(51) Int. Cl. H02K 1/14

(52) U.S. Cl. CPC H02K 1/143
USPC 310/114; 310/216.075

(57) ABSTRACT

A transverse flux machine includes a stator having a circular coil wound in a rotational direction, a plurality of first ferromagnets arranged in the rotational direction, each of the first ferromagnets surrounding a part of the circular coil; and a rotor arranged to face the first ferromagnets across a gap, the rotor being rotatable about a center axis of the circular coil; wherein the rotor includes a plurality of second ferromagnets arranged in the rotational direction; and a flux-generation part arranged between adjacent ones of the second ferromagnets, each of the second ferromagnets to generate a magnetic field in the rotational direction.

### CROSS-REFERENCE TO RELATED APPLICATION

This application is based upon and claims the benefit of priority from Japanese Patent Application No. 2013-205870, filed on Sep. 30, 2013; the entire contents of which are incorporated herein by reference.

### FIELD

Embodiments described herein relate generally to a transverse flux machine and a vehicle using the same.

### BACKGROUND

A transverse flux machine has a rotor which is rotatable about an axis, and a stator surrounding the rotor. The stator has a circular coil wound coaxially with the rotor, and a plurality of U-shaped ferromagnets surrounding the coil and arranged on a circumference. The U-shaped ferromagnets have a magnetic pole at both ends. The rotor has permanent magnets and ferromagnets alternately arranged on a circumference. The permanent magnets and the ferromagnets of the rotor are arranged to face the magnetic poles of the U-shaped ferromagnets of the stator.

### BRIEF DESCRIPTION OF THE DRAWINGS

FIG. 1 shows an oblique view of a transverse flux machine according to a first embodiment.

FIG. 2 shows a cross-section of the transverse flux machine of FIG. 1.

FIG. 3 shows a front view showing a schematic of a rotor and a stator of FIG. 1.

FIG. 4 shows an oblique view schematically showing a driving component according to the first embodiment.

FIG. 5 shows a sectional oblique view showing a schematic of a rotor and a stator of FIG. 4.

FIGS. 6(A), (B) and (C) show a cross-sectional view of the driving component of FIG. 4.

FIG. 7 shows an oblique view of a transverse flux machine according to a second embodiment.

FIG. 8 shows a cross-section of the transverse flux machine of FIG. 7.

FIG. 9 shows a front view showing a schematic of a rotor and a stator of FIG. 7.

FIG. 10 shows an oblique view schematically showing a driving component according to the second embodiment.

FIG. 11 shows a sectional oblique view showing a schematic of a rotor and a stator of FIG. 10.

FIGS. 12(A), (B) and (C) show a cross-sectional view of the driving component of FIG. 10.

FIG. 13 shows a schematic of a driving system of a transverse flux machine according to a third embodiment.

FIG. 14 shows a schematic of a driving circuit of FIG. 13.

FIG. 15 shows a three-phase current to a circular coil of FIG. 14.

FIG. 16 shows a three-phase current to a circular coil of FIG. 14.

FIG. 17 shows a schematic of a vehicle according to a fourth embodiment.

FIG. 18 shows a schematic of a vehicle according to the fourth embodiment.

FIG. 19 shows a schematic of a vehicle according to the fourth embodiment.

FIG. 20 shows a schematic of a vehicle according to the fourth embodiment.

FIGS. 21(A), (B), (C) show a partial cross-sectional view of a stator and a rotor according to a comparative example.

### DETAILED DESCRIPTION

In the transverse flux machine, a torque is generated by supplying a polyphase current to the circular coils. However, when the transverse flux machine is driving, a cogging torque which is one of the causes of the torque ripple is also generated. Lower cogging torque is desired for smooth driving of the transverse flux machine.

In an aspect of one embodiment as shown below, a transverse flux machine realizing low a cogging torque and a vehicle using the same can be provided.

According to an aspect of certain embodiments, there is provided a transverse flux machine comprising: a stator having a circular coil wound in a rotational direction, a plurality of first ferromagnets arranged in the rotational direction, each of the first ferromagnets surrounding a part of the circular coil; and a rotor arranged to face the first ferromagnets across a gap, the rotor being rotatable about a center axis of the circular coil; wherein the rotor includes a plurality of second ferromagnets arranged in the rotational direction; and a flux-generation part arranged between the adjacent second ferromagnets, each of the flux-generation part to generate a magnetic field in the rotational direction.

According to an aspect of other embodiments, a vehicle including the transverse flux machine is provided.

Hereinbelow, embodiments will be explained in further detail with reference to the drawings.

### First Embodiment

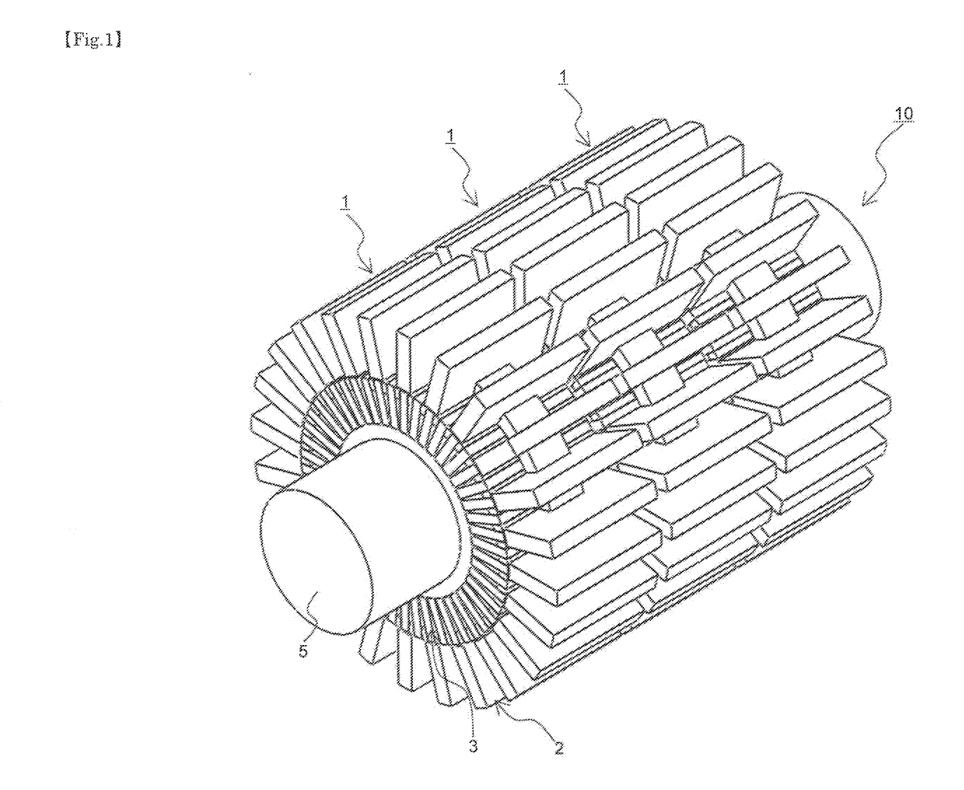

FIG. 1 shows an oblique view of a transverse flux machine 10 according to a first embodiment. The transverse flux machine 10 has a rotational axis 5, and a plurality of driving components 1 (three driving components 1 are shown in FIG. 1). These driving components 1 are arranged along an axial direction of the rotational axis 5. Each of the plurality of driving components 1 has a stator 2 and a rotor 3. Each relative phase of the stator 2 and the rotor 3 in the rotational direction differs among driving components. The transverse flux machine 10 has a cylindrical housing (not shown) accommodating the plurality of driving components 1. The rotational axis 5 is rotatably supported by a pair of bearings arranged in the housing.

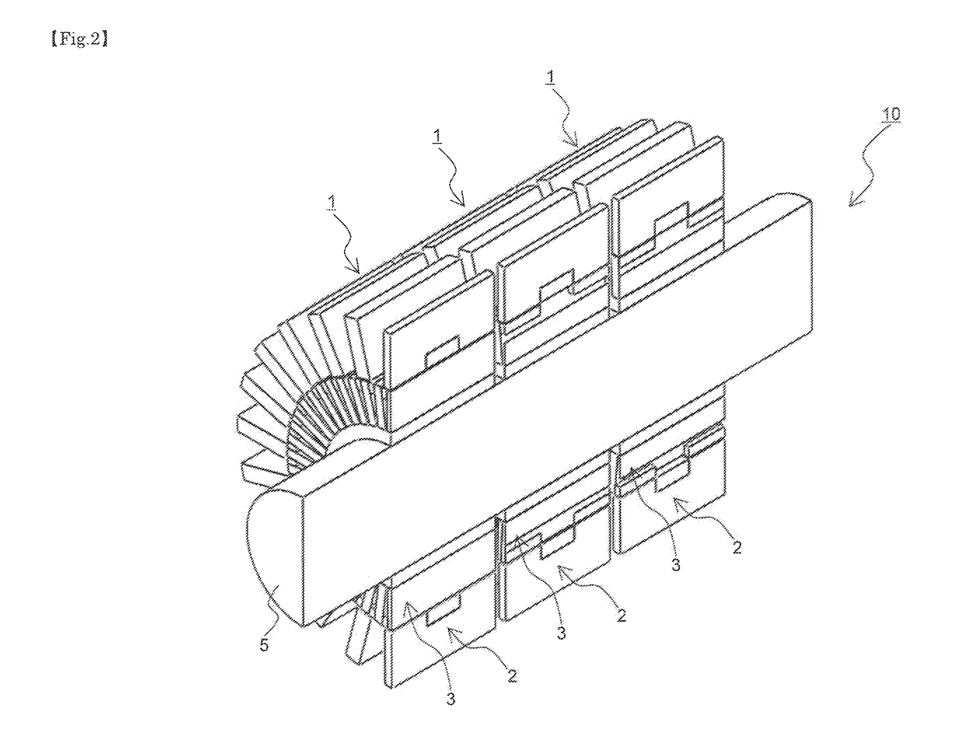

In FIG. 2, the cross-section of the transverse flux machine 10 along a virtual plane through the rotational axis 5 and parallel to the rotational axis 5 is shown. In the following, the cross-section is the cross section at a virtual plane through the rotational axis 5 and parallel to the rotational axis 5, i.e. the cross section along the direction perpendicular to the rotational direction of the rotor 3. As shown in FIG. 2, the rotor 3 is attached to the rotational axis 5, a plurality of the rotors 3 are connected to each other via the rotational axis 5. The rotor 3 is rotatable relative to the stator 2 (a plurality of stator cores described below) about the rotational axis 5. A connecting part made of nonmagnetic material (not shown) is provided between the adjacent two stators 2, and the stators 2 are connected to each other via the connecting part. The stator 2 is fixed to the housing. In each of the driving components 1, the rotor 3 and the stator 2 (stator core described below) are opposed across a gap in a radial direction perpendicular to the axial direction of the rotational axis 5. In this embodiment, the rotor 3 is located inside the stator 2.

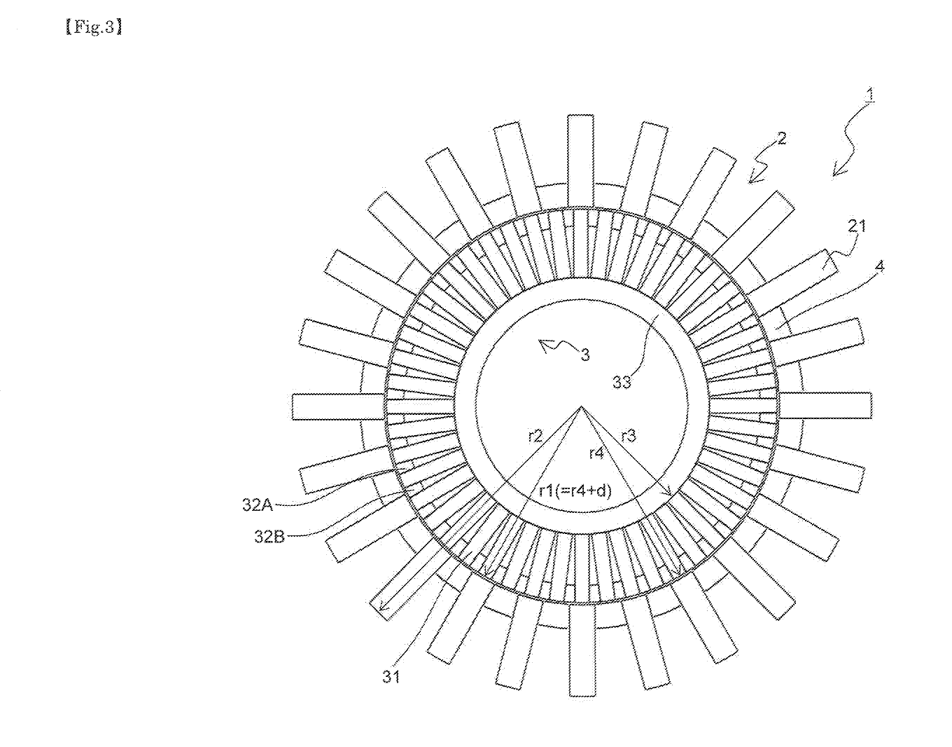

FIG. 3 is a front view showing a schematic of the rotor and the stator. The driving component 1 has the stator 2, and the rotor 3 which is provided within the inner circumference of the stator 2 through a gap d between the stator 2 and the rotor 3.

The stator 2 has a circular coil 4 wound in a circumferential direction (rotational direction) on a virtual cylinder that is placed at a distance (r1) from the center of the rotational axis 5, and a plurality of stator cores (a first ferromagnet) 21 surrounding a part of the coil 4 in a circumferential direction (rotational direction) separately.

The rotor 3 has a plurality of rotor cores (a second ferromagnet) 31 in the circumferential direction (rotational direction) on a virtual cylinder that is placed at a distance (r3) from the center of the rotational axis 5, separately. Furthermore, the rotor 3 has a first flux-generation part 32A between the first and second cores (members) of three consecutive rotor cores 31, and a second flux-generation part 32B between the second and third cores of the three consecutive rotor cores 31. The first, second and third cores are arranged in the circumferential direction in succession. The inner side of the rotor cores 31 is connected to an annular part 33 made of non-magnetic material.

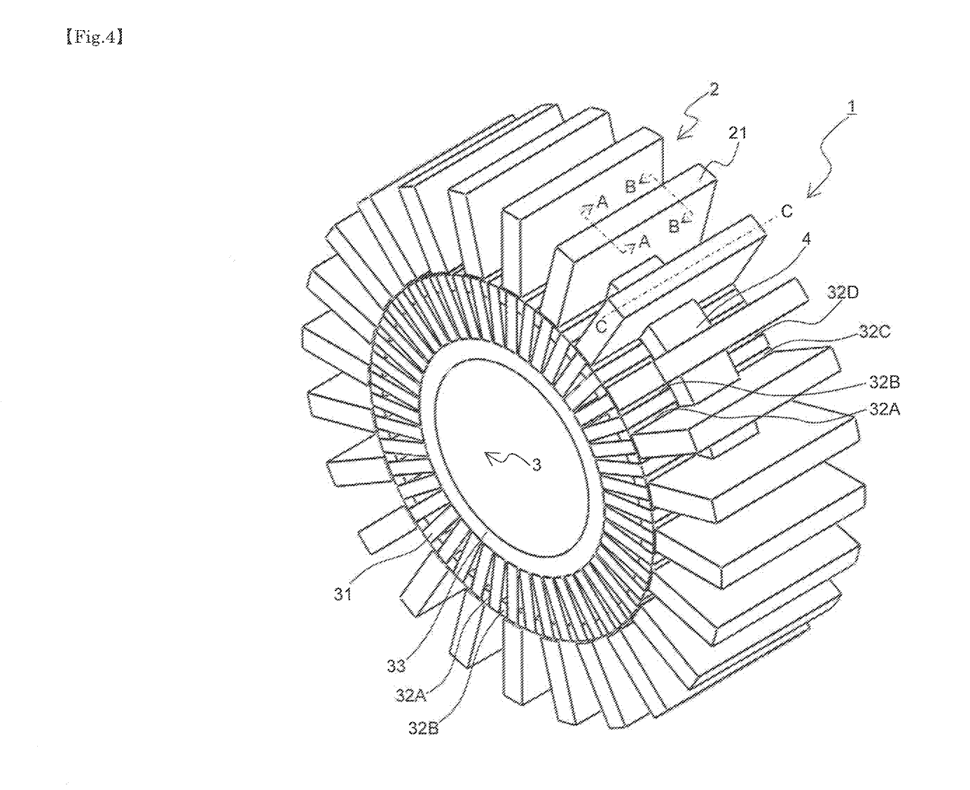

FIG. 4 is an oblique view schematically showing the driving component according to the first embodiment. The rotor 3 has a third flux-generation part 32C between the first and second cores of the three consecutive rotor cores 31, and a fourth flux-generation part 32D between the second and third cores of the three consecutive rotor cores 31. The first flux-generation part 32A and the third flux-generation part 32C are opposed in the axial direction, and the second flux-generation part 32B and the fourth flux-generation part 32D are opposed in the axial direction.

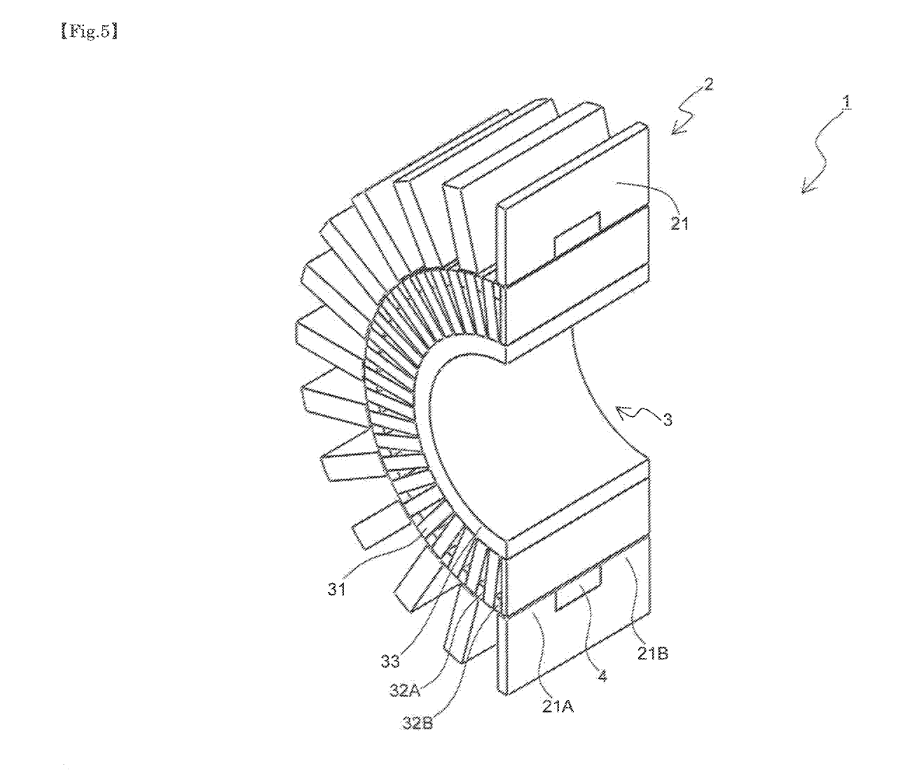

FIG. 5 is a sectional oblique view showing a schematic of the rotor 3 and the stator 2. Each stator core 21 has a U-shaped form. Furthermore, the stator core 21 has a first magnetic pole portion 21A and a second magnetic pole portion 21B in ends of the U-shaped form. The stator core 21 holds the coil 4 between the first magnetic pole portion 21A and the second magnetic pole portion 21B.

The first flux-generation part 32A and the second flux-generation part 32B are arranged at the edge close to the first magnetic pole portion 21A in the radial direction so as to correspond to the position in the axial direction of the first magnetic pole portion 21A. The rotor core 31 and the first magnetic pole portion 21A face for certain rotational positions of the rotor 3. The third flux-generation part 32C and the fourth flux-generation part 32D are arranged at the edge close to the second magnetic pole portion 21B in the radial direction so as to correspond to the position in the axial direction of the second magnetic pole portion 21B. The rotor core 31 and the second magnetic pole portion 21B face for certain rotational positions of the rotor 3.

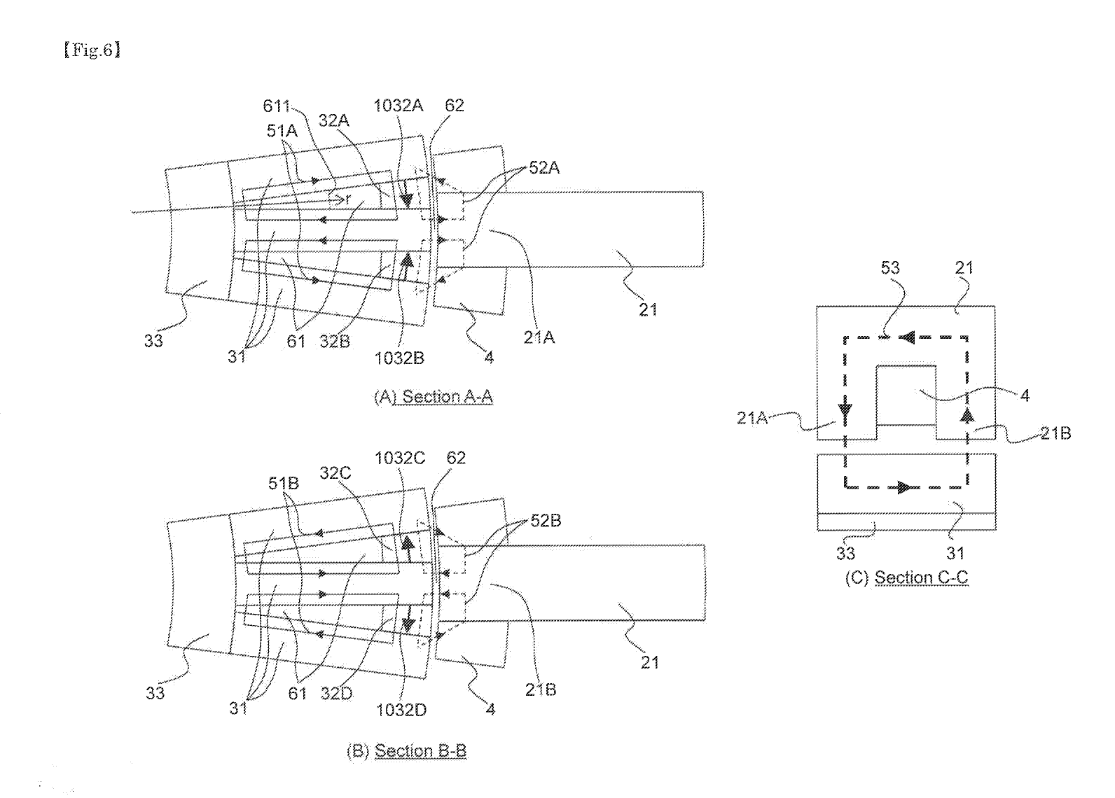

FIGS. 6(A), (B) and (C) are diagrams illustrating an example of a time when the rotor core 32 and stator core 21 are opposed. FIGS. 6(A), (B) and (C) are A-A cross-sectional view, B-B cross-sectional view and C-C cross-sectional view of the driving component 1 of FIG. 4 respectively.

The first flux-generation part 32A and the second flux-generation part 32B are permanent magnets which are bonded to the side surfaces of the adjacent rotor cores 31 via an adhesive material (not shown). The first flux-generation part 32A and the second flux-generation part 32B flow magnetic flux in the rotational direction (the direction of the arrows 1032A and 1032B, respectively). The respective directions of the arrows 1032A and 1032B are opposite to the rotation direction. Then, closed magnetic circuits 51A and 52A are formed among the stator core 21 and the rotor cores 31 via the first flux-generation part 32A and the second flux-generation part 32B. The third flux-generation part 32C and the fourth flux generation part 32D are permanent magnets which are bonded to the side surfaces of the adjacent rotor cores 31 via an adhesive material (not shown). The third flux-generation part 32C and the fourth flux generation part 32D flow magnetic flux in the rotational direction (the directions of the arrows 1032C and 1032D, respectively). The directions of the arrows 1032C and 1032D are opposite to the rotation direction. Then, closed magnetic circuits 51B and 52B are formed among the stator core 21 and the rotor cores 31 via the third flux-generation part 32C and the fourth flux generation part 32D. Moreover, because the directions of the arrows 1032A and 1032B are opposite and the directions of the arrow 1032C and 1032D are opposite, high-concentration magnetic flux flows through the rotor core 31.

Although the first to the fourth flux-generation parts 32A, 32B, 32C and 32D having magnetization directions substantially perpendicular to the side surface of the adjacent rotor cores 31 are favorable, the magnetic field generated toward the outer side of the radial direction (to stator 2 from the rotor 3) by repelling of magnetic fields due to the first flux-generation part 32A and the second flux-generation part 32B in the rotor cores 31 can be used. Similarly, the magnetic field generated toward the outer side of the radial direction (to stator 2 from the rotor 3) by repelling of magnetic fields due to the third flux-generation part 32C and the fourth flux-generation part 32D in the rotor cores 31 can be used.

The magnetizing permanent magnet or the member generating magnetic field can be used as the first to the fourth flux-generation parts 32A, 32B, 32C and 32D. For example, the member can include an iron core and a coil, and the magnetic flux is generated by supplying current to the coil.

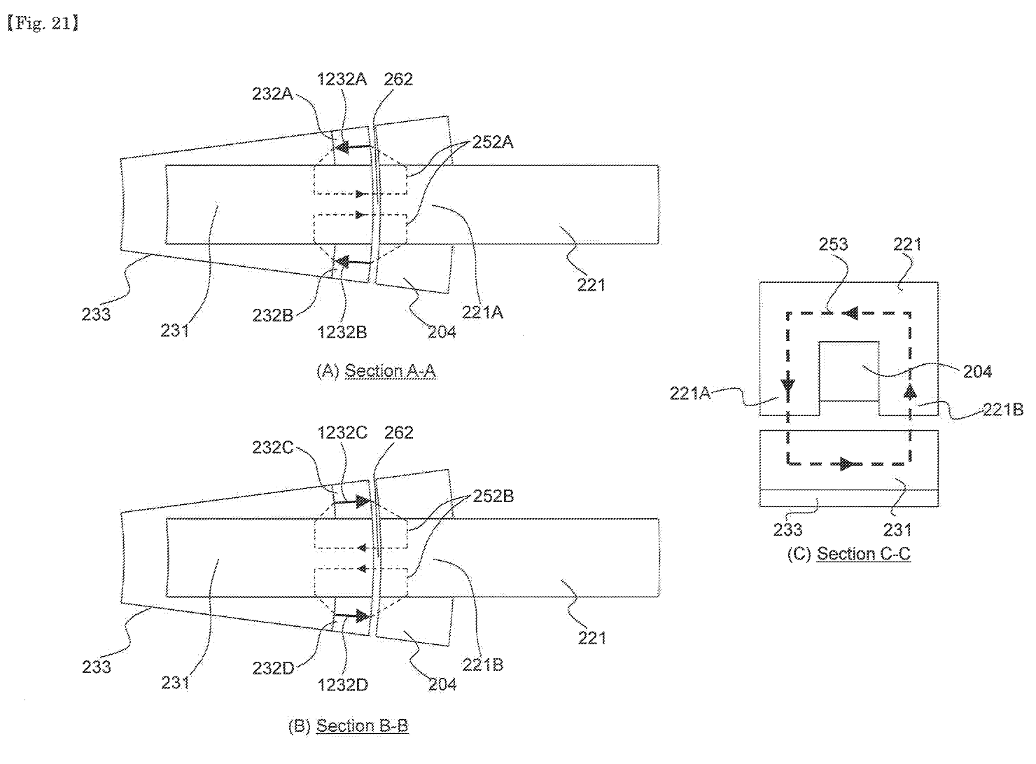

In a conventional transverse flux machine, as shown in FIGS. 21(A), (B), and (C) a flux-generation part 232 (i.e., parts 232A, 232B, 232C, 232D) generates magnetic field in the direction of an arrow 1232 (i.e., arrows 1232A, 1232B, 1232C, 1232D) (the radial direction), the magnetic field flows along the flux generation part 232, the rotor core 233, a gap 262, a stator core 221 (i.e., cores 221A, 22B), the gap 262 and the flux-generation part 232 (magnetic circuit 252 (I.e., circuits 252A, 252B)). Therefore, even when the current is not supplied, a cogging torque is generated because magnetic field due to the flux-generation part 232 affects the stator core 221. When the current is supplied, a torque corresponding to the driving current is generated. The torque includes pulsation (torque ripple) which is generated by the same cause of the cogging torque. Although fluctuation of rotational speed is caused by the pulsation torque during the rotation, the fluctuation caused by the pulsation torque in the high-speed rotation is generally small. When the cogging torque is small, the pulsation torque can be kept small generally. In order to perform a smooth rotation at low speed, designing a motor so as to make the cogging torque smaller is desirable.

Hereinbelow, mechanism of the driving component 1 that suppresses the cogging torque when the current is not supplied and generates a high torque when the current is supplied will be explained with reference to FIGS. 6(A), (B) and (C).

When the circular coil 4 is not excited, magnetic saturation (the magnetization amount of the iron core inside is maximum) of the stator cores 21 and rotor cores 31 does not proceed. Most of magnetic fluxes by the first flux-generation part 32A and the second flux-generation part 32B flow along the magnetic circuit 51A, the path of which includes the iron cores in large part, while little magnetic fluxes flow along the magnetic circuit 52A including the large gap. Most of magnetic fluxes by the third flux-generation part 32C and the fourth flux-generation part 32D flow along the magnetic circuit 51B, the path of which includes the iron cores in large part, while little magnetic fluxes flow along the magnetic circuit 52B including the large gap. Then, the magnetic flux flowing along the magnetic circuit 51A and magnetic circuit 51B does not affect the stator 2, and therefore, cogging torques are not generated.

When the circular coil 4 is excited, magnetic fluxes generated by the current flow along the magnetic circuit 53 which includes the stator core 21 and the rotor core 31, magnetic saturation of the stator cores 21 and rotor cores 31 proceeds. When the stator cores 21 and the rotor cores 31 are magnetically saturated, the ease of flow of the magnetic flux in the cores becomes almost the same as that in the gap. Therefore, magnetic fluxes by the first flux-generation part 32A and the second flux-generation part 32B flow along the small path as shown by the magnetic circuit 52A, and similarly, magnetic fluxes by the third flux-generation part 32C and the fourth flux-generation part 32D flow along the small path as shown by the magnetic circuit 52B. The torque is generated by interaction among the magnetic flux flows along the magnetic circuits 52A, 52B and the magnetic circuit 53.

Furthermore, when the circular coil 4 is not excited, a percentage of an amount of magnetic flux flowing along the magnetic circuits 51A and 51B, or 52A and 52B is determined approximately by a ratio of a size of a gap 61 (between the adjacent rotor cores 31) and a size of a gap 62 (between the stator cores 21 and rotor cores 31). The gap 61 extends toward the outer side in the radial direction r, the gap 61 being represented as g(r)=g₀+(r−r₀)tan (θ), wherein g₀ represents the innermost gap length, θ represents the angle formed by the radial direction and the long side of the rotor core 31, g(r) has a minimum value at the part contacted with the annular non-magnetic member 33 (r=r₀) and g(r) has a maximum value at the part contacted with a first flux-generation part 32A (r=rₘ). If the magnetic flux flows along the gap 611 in a direction perpendicular to the radial direction from the small sections dr for the radial position=r, a magnetic resistance per the unit length is represented as g(r)cos(θ)/(μ₀dr), where μ₀ is permeability of free space. The gap 611 is in parallel for the radial position r=r₀˜rₘ, if a magnitude of a magnetic resistance of the rotor cores 31 is negligible, a magnetic resistance Rₘ₁ of the gap 61 being represented as sinθ/μ₀ln(gₘ−g₀) by integrating with respect to r, where gₘ represents g(rₘ).

On the other hand, the magnetic circuit 52A or 52B includes at least two gap lengths d and, although it depends on the rotational position, and therefore, magnetic resistance Rₘ₂ is 2d/μ₀t at most, where t is one-half of the thickness of the rotor cores 31 in the circumferential direction. Therefore, by designing so that Rₘ₁<<Rₘ₂ when the circular coil 4 is not excited, most of the magnetic fluxes due to the first flux-generation part 32A flows along the magnetic circuit 51A. Further, designing Rₘ₁<<Rₘ₂ is almost the same as designing so that g₀<<d.

### Second Embodiment

A transverse flux machine according to a second embodiment differs from the transverse flux machine according to the first embodiment in that the rotor core is connected to an annular member of ferromagnetic material.

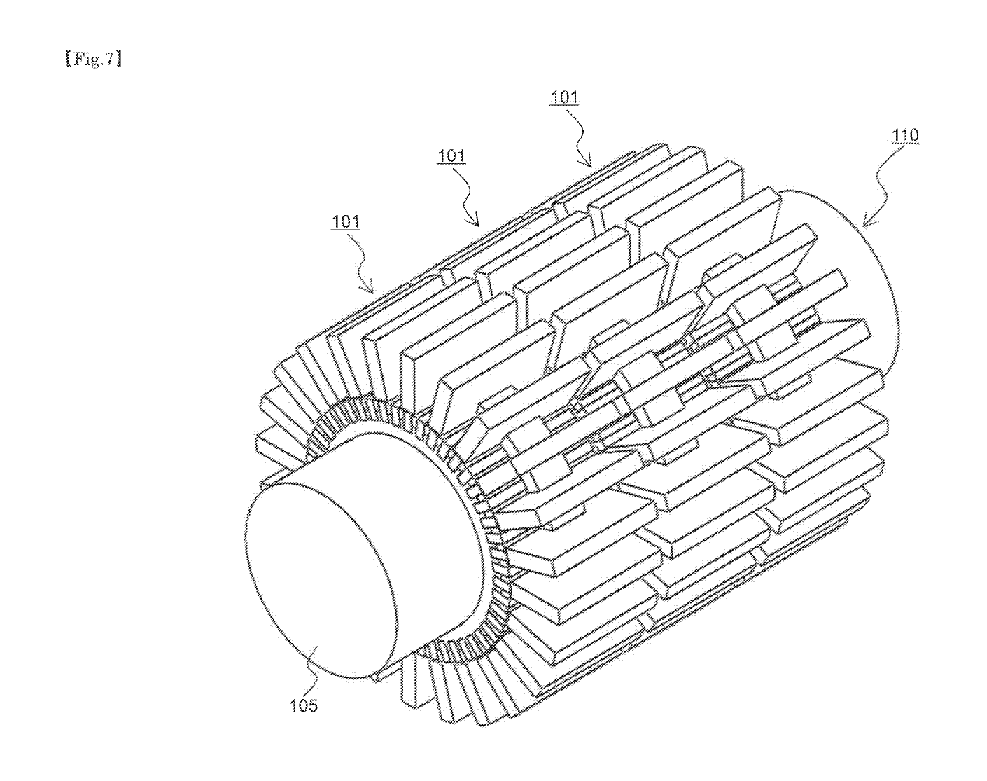

FIG. 7 shows an oblique view of a transverse flux machine 110 according to the second embodiment. The transverse flux machine 110 has a rotational axis 105, and a plurality of driving components 101 (three driving components 101 are shown in FIG. 7). These driving components 101 are arranged along an axial direction of the rotational axis 105. Each of the plurality of driving components 101 has a stator 102 and a rotor 103. Each relative phase of the stator 102 and the rotor 103 in the rotational direction differs among driving components. The transverse flux machine 110 has a cylindrical housing (not shown) accommodating the plurality of driving components 101. The rotational axis 105 is rotatably supported by a pair of bearings arranged in the housing.

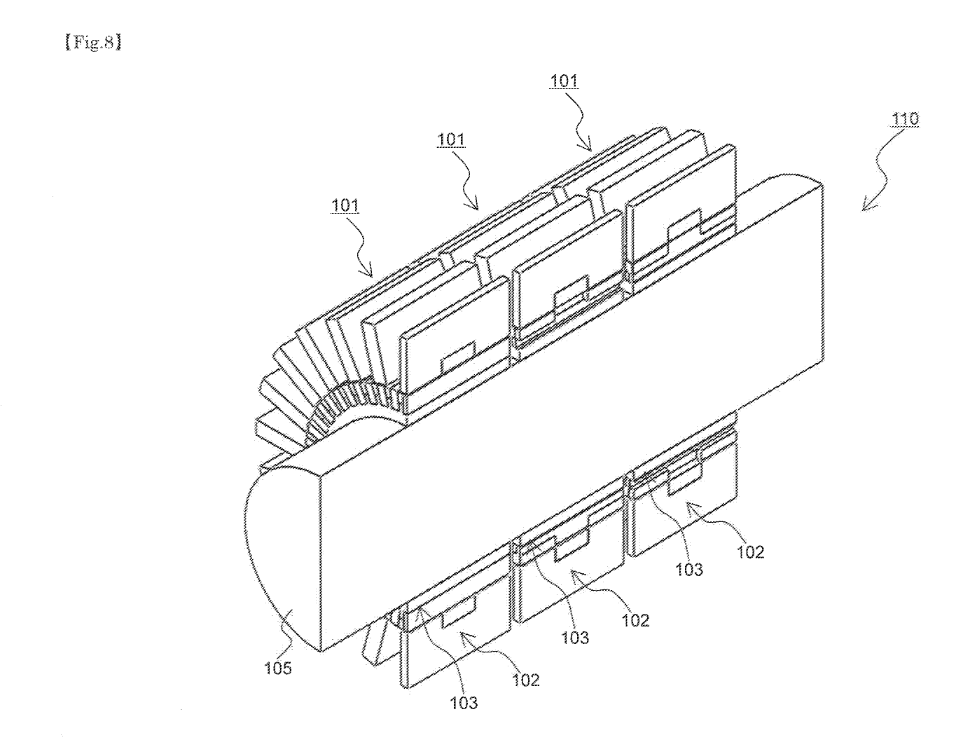

In FIG. 8, the cross-section of the transverse flux machine 110 along the virtual plane through the rotational axis 105 and parallel to the rotational axis 105 is shown. In the following, the cross-section is the cross section at a virtual plane through the rotational axis 105 and parallel to the rotational axis 105, i.e., the cross section along the direction perpendicular to the rotational direction of the rotor 103. As shown in FIG. 8, the rotor 103 is attached to the rotational axis 105, a plurality of the rotors 103 are connected to each other via the rotational axis 105. The rotor 103 is rotatable relative to the stator 102 (a plurality of stator cores described below) about the rotational axis 105. A connecting part made of non-magnetic material (not shown) is provided between the adjacent two stators 102, the stators 102 being connected to each other via the connecting part. The stator 102 is fixed to the housing. In each of the driving components 101, the rotor 103 and the stator 102 (stator core described below) are opposed across the gap in a radial direction perpendicular to the axial direction of the rotational axis 105. In this embodiment, the rotor 103 is located inside the stator 102.

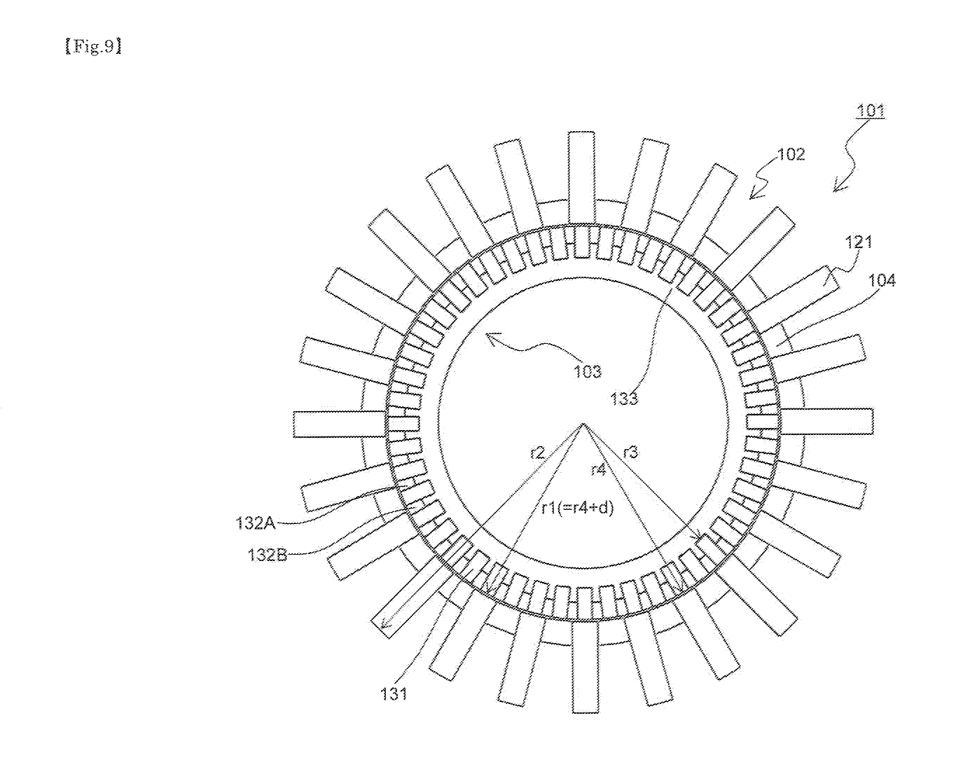

FIG. 9 is a front view showing a schematic of the rotor and the stator. The driving component 101 has the stator 102, and the rotor 103 which is provided inside inner circumference of the stator 102 through a gap d.

The stator 102 has a circular coil 104 wound in a circumferential direction (rotational direction) on a virtual cylinder that is placed at a distance (r1) from the center of the rotational axis 105, and a plurality of stator cores (a first ferromagnet) 121 surround a part of the coil 104 in a circumferential direction (rotational direction) separately.

The rotor 103 has a plurality of rotor cores (a second ferromagnet) 131 in the circumferential direction (rotational direction) on a virtual cylinder that is placed at a distance (r3) from the center of the rotational axis 105, separately. Furthermore, the rotor 103 has a first flux-generation part 132A between the first and second cores of three consecutive rotor cores 131, and a second flux-generation part 132B between the second and third cores of three consecutive rotor cores 131. The first, second and third cores are arranged in the circumferential direction in succession. The inner side of the rotor cores 131 is connected to an annular part 133 (a third ferromagnet) made of ferromagnetic material.

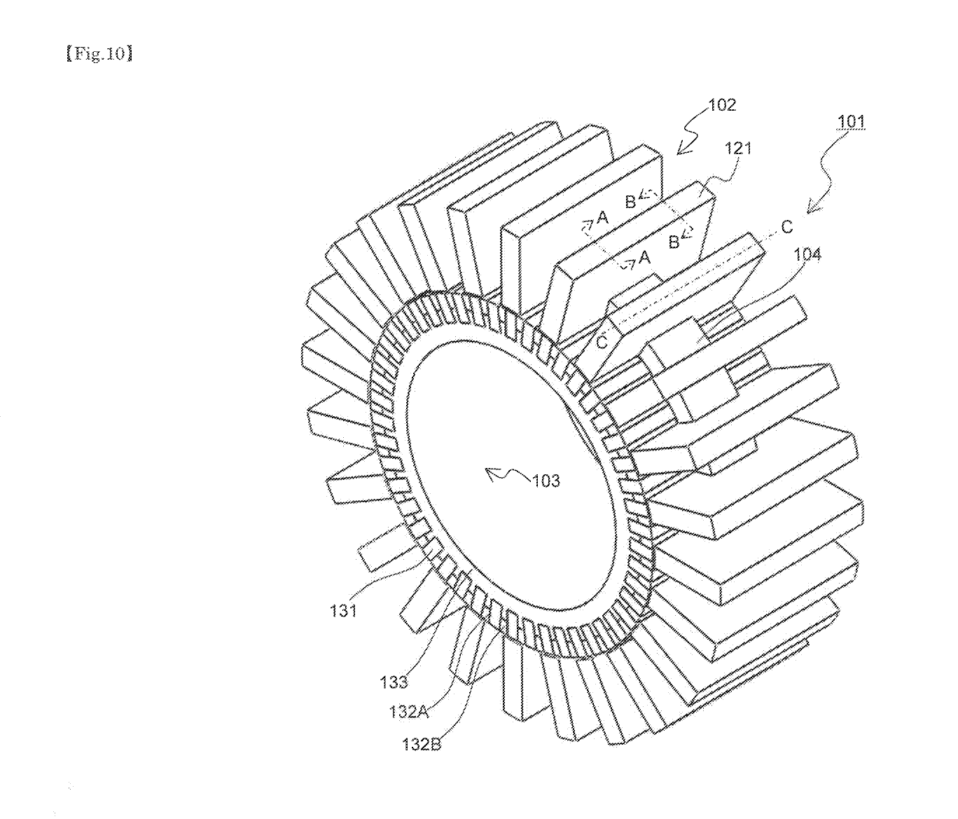

FIG. 10 is an oblique view schematically showing the driving component according to the second embodiment. The rotor 103 has a third flux-generation part 132C between the first and second cores of the three consecutive rotor cores 131, and a fourth flux-generation part 132D between the second and third cores of the three consecutive rotor cores 131. The first flux-generation part 132A and the third flux-generation part 132C are opposed in the axial direction, and the second flux-generation part 132B and the fourth flux-generation part 132D are opposed in the axial direction.

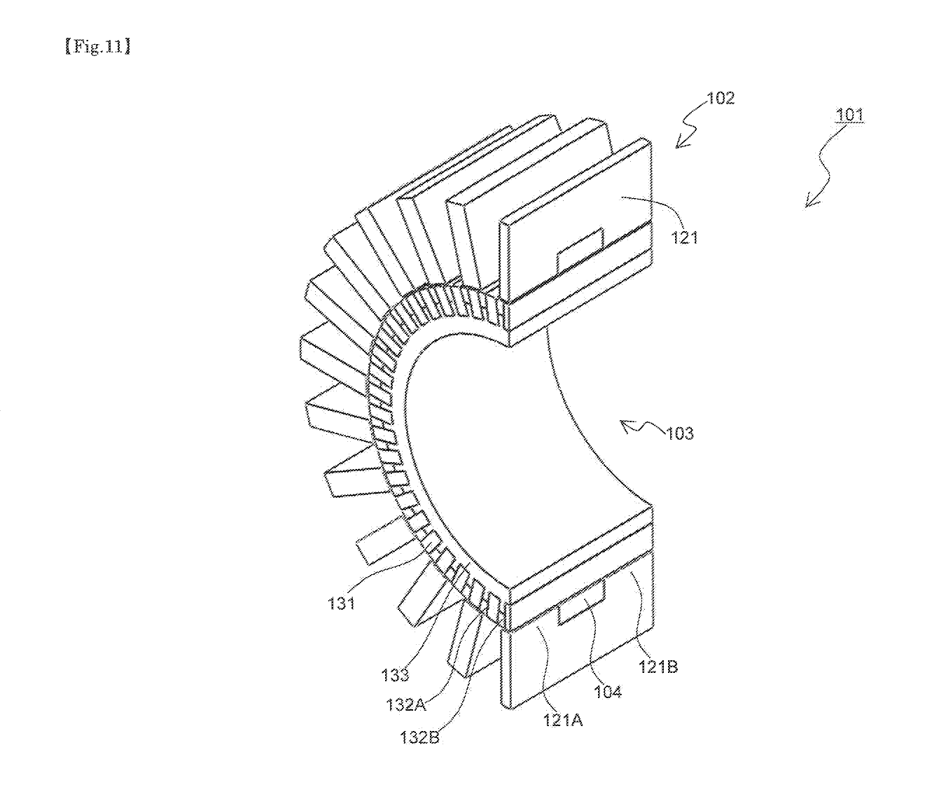

FIG. 11 is a sectional oblique view showing a schematic of the rotor and the stator. Each stator core 121 has a U-shaped form. Furthermore, the stator core 121 has a first magnetic pole portion 121A and a second magnetic pole portion 121B in ends of the U-shaped form. The stator core 121 holds the coil 104 between the first magnetic pole portion 121A and the second magnetic pole portion 121B.

The first flux-generation part 132A and the second flux-generation part 132B are arranged at the edge close to the first magnetic pole portion 121A in the radial direction so as to correspond to the position in the axial direction of the first magnetic pole portion 121A. The rotor core 131 and the first magnetic pole portion 121A face for certain rotational positions of the rotor 103. The third flux-generation part 132C and the fourth flux-generation part 132D are arranged at the edge close to the second magnetic pole portion 121B in the radial direction so as to correspond to the position in the axial direction of the second magnetic pole portion 121B. The rotor core 131 and the second magnetic pole portion 121B face for certain rotational positions of the rotor 103.

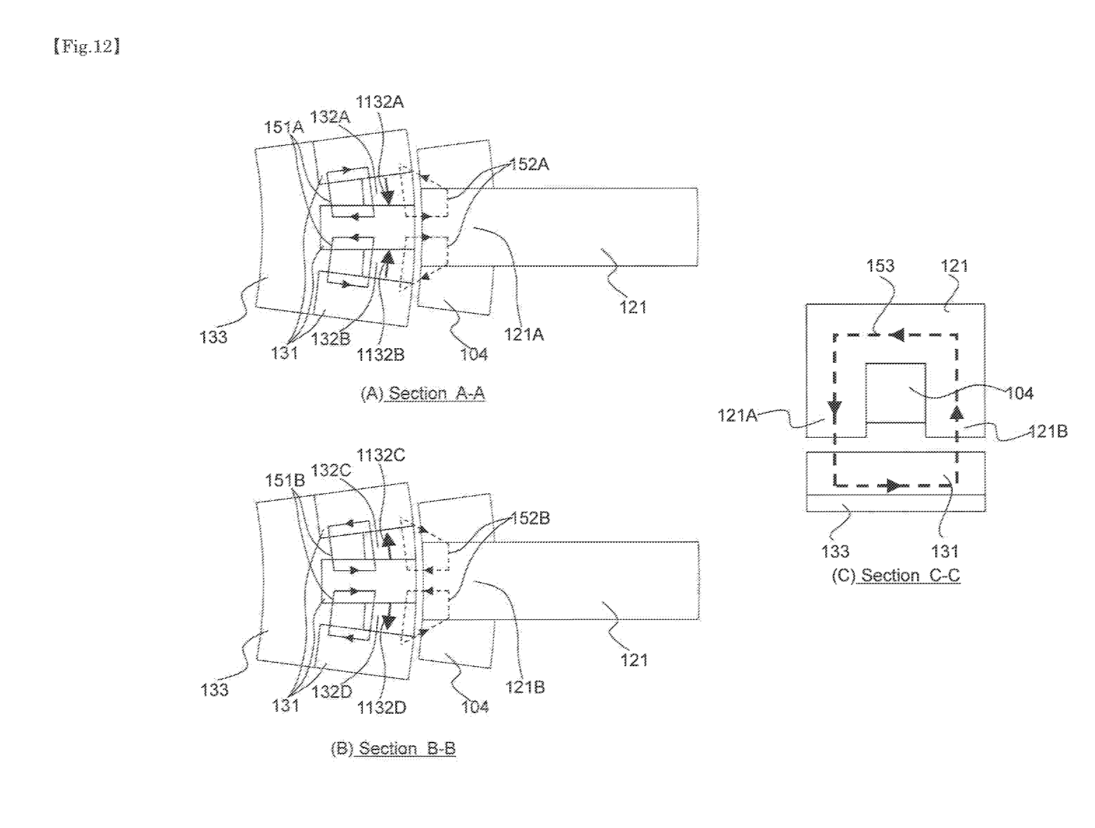

FIGS. 12(A), (B) and (C) are diagrams illustrating as an example of a time when the rotor core 132 and stator core 121 are opposed. FIGS. 12(A), (B) and (C) are A-A cross-sectional view, B-B cross-sectional view and C-C cross-sectional view of the driving component 101 of FIG. 10, respectively.

The first flux-generation part 132A and the second flux-generation part 132B are permanent magnets which are bonded to the side surfaces of the adjacent rotor cores 131 via an adhesive material (not shown). The first flux-generation part 132A and the second flux-generation part 132B flow magnetic flux in the rotational direction (the directions of arrows 1132A and 1132B, respectively). The directions of arrows 1132A and 1132B are opposite to the rotation direction. Then, closed magnetic circuits 151A and 152A are formed among the stator core 121 and the rotor cores 131 via the first flux-generation part 132A and the second flux-generation part 132B. The third flux-generation part 132C and the fourth flux-generation part 132D are permanent magnets which are bonded to the side surfaces of the adjacent rotor cores 131 via an adhesive material (not shown). The third flux-generation part 1320 and the fourth flux-generation part 132D flow magnetic flux in the rotational direction (the directions of arrows 1132C and 1132D, respectively). The directions of arrows 1132C and 1132D are opposite to the rotation direction. Then, closed magnetic circuits 151B and 152B are formed among the stator core 121 and the rotor cores 131 via the third flux-generation part 132C and the fourth flux-generation part 132D. Moreover, because the directions of arrows 1132A and 1132B are opposite and the directions of arrows 1132C and 1132D are opposite, high-concentration magnetic flux flows through the rotor core 131.

Although the first to the fourth flux-generation parts 132A, 132B, 132C and 132D having magnetization directions substantially perpendicular to the side surface of the adjacent rotor cores 131 are favorable, the magnetic field generated toward the outer side of the radial direction (to stator 102 from the rotor 103) by repelling of magnetic fields due to the first flux-generation part 132A and the second flux-generation part 132B in the rotor cores 131 can be used. Similarly, the magnetic field generated toward the outer side of the radial direction (to stator 102 from the rotor 103) by repelling of magnetic fields due to the third flux-generation part 132C and the fourth flux-generation part 132D in the rotor cores 131 can be used.

The magnetizing permanent magnet or the member generating a magnetic field can be used as the first to the fourth flux-generation parts 132A, 132B, 132C and 132D. For example, the member can include an iron core and a coil, and the magnetic flux is generated by supplying current to the coil.

Hereinbelow, a mechanism of the driving component 101 that suppresses a togging torque when the current is not supplied and generates a high torque when the current is supplied will be explained with reference to FIGS. 12 (A), (B) and (C).

When the circular coil 104 is not excited, magnetic saturation (the magnetization amount of the iron core inside is maximum) of the stator core 121 and rotor core 131 does not proceed. Most of magnetic fluxes by the first flux-generation part 132A and the second flux-generation part 132B flow along the magnetic circuit 151A, the path of which includes the iron cores in large part, while little magnetic fluxes flow along the magnetic circuit 152A including the large gap. Most of magnetic fluxes by the third flux-generation part 132C and the fourth flux-generation part 132D flow along the magnetic circuit 151B, the path of which includes the iron cores in large part, while little magnetic fluxes flow along the magnetic circuit 152B including the large gap. The magnetic flux that flows along the magnetic circuit 151A and magnetic circuit 151B does not affect the stator 102, and therefore, cogging torques are not generated.

Compared with the first embodiment, because the transverse flux machine 110 has the annular ferromagnetic part 133, the magnetic circuits 151A and 151B are shorter than magnetic circuits 51A and 51B larger amount of magnetic flux by flux-generation parts 132A, 132B, 1320, 132D flow easily. Therefore, magnetic flux flowing along the magnetic circuits 152A and 152B decreases, and therefore, the cogging torque can be decreased.

When the circular coil 104 is excited, magnetic fluxes generated by the current flow along the magnetic circuit 153 which passes through the stator core 121 and the rotor core 131, magnetic saturation of the stator core 121 and rotor core 131 proceeds. When the stator cores 121 and the rotor cores 131 are magnetically saturated, the ease of flow of the magnetic flux in the cores becomes almost the same as that in the gap. Therefore, magnetic fluxes by the first flux-generation part 132A and the second flux-generation part 132B flow along the small path as shown by the magnetic circuit 152A, and similarly, magnetic fluxes by the third flux-generation part 132C and the fourth flux-generation part 132D flow along the small path as shown by the magnetic circuit 152B. The torque is generated by interaction among the magnetic flux flows along the magnetic circuits 152A, 152B and the magnetic circuit 153.

Compared with the first embodiment, because the annular ferromagnetic part 133 is in contact with the rotor cores 131, the magnetic circuits 151A and 151E do not include gaps and the magnetic resistance is small. Therefore, when the circular coil 104 is not excited, most of magnetic fluxes flow along the magnetic circuits 151A and 151B.

### Third Embodiment

Hereinbelow, a driving system of a transverse flux machine according to a third embodiment will be explained.

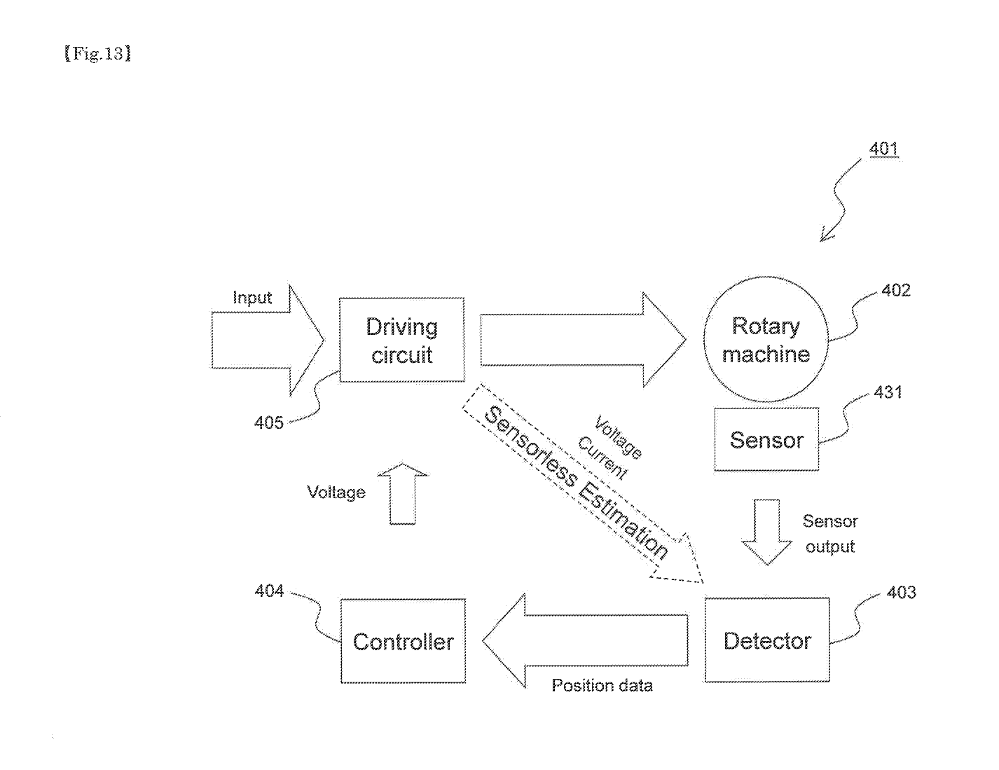

FIG. 13 is a schematic of the driving system of the transverse flux machine 401 according to the third embodiment. As shown in FIG. 13, the driving system 401 includes the transverse flux machine (rotary machine) 402 of the first embodiment, a detector 403 of rotational positions, a controller 404 of rotating, and a driving circuit 405. Alternatively, the transverse flux machine according to the second embodiment can be used as the rotary machine 402.

The detector 403 detects rotational positions of the rotor 3 based on the output from a sensor 431 mounted on the driving axis of the rotary machine 402, or detects rotational positions of the rotor based on the output from the driving circuit 405 and a physical model of the rotary machine 402 (sensorless estimation).

The controller 404 obtains the position data from the detector 403, and applies the voltage to the driving circuit 405 based on the control algorithm implemented.

The driving circuit 405 supplies the current to a circular coil corresponding to the coil 4 of the first embodiment by power supply from the controller 404 and a power unit (not shown). As a result, a torque is generated in the rotor, and the rotary machine 402 is driven.

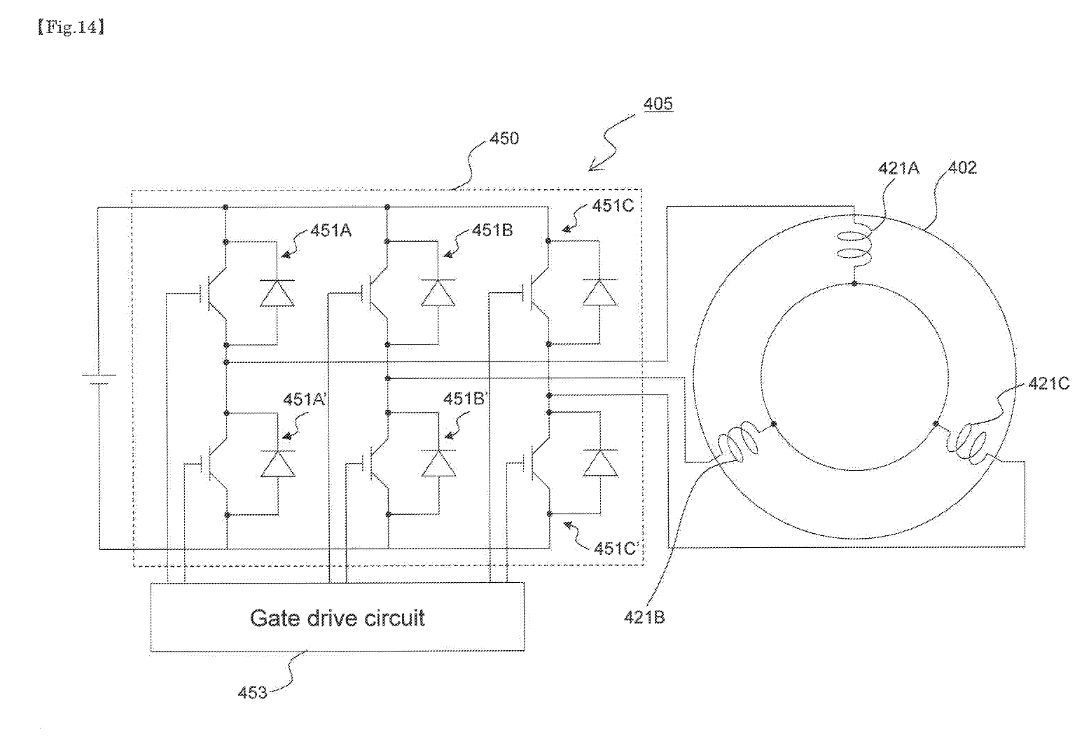

FIG. 14 is a schematic of the driving circuit 405. As shown is FIG. 14, the driving circuit 405 includes a switching circuit 450 and a gate drive circuit 453. The switching circuit 450 has a plurality of switching units 451 (i.e., 451A, 451B, 451C, 451A′, 451B′, 451C′) including, for example, IGBTs (Insulated-gate bipolar transistors) and diodes. Each switching unit 451 is connected to circular coils 421 (421A, 421B, 421C) corresponding to the coils 4, by each phase of a bridge circuit. Each switching unit 451 is driven by pulse signals from the gate drive circuit 453. In FIG. 14, the rotary machine 402 is three-phase, that is, the rotary machine 402 includes three driving components including the rotor and stator in FIG. 1, and the circular coil is three-phase.

If the rotary machine 402 has a different number of phases, the switching circuit 450 for the number of phases is applicable. In this case, the switching circuit 450 including the switching unit(s), the number of which is corresponding to the number of the phase (s), is used. Furthermore, a power amplifier circuit (not shown) can be connected with the circular coils 421.

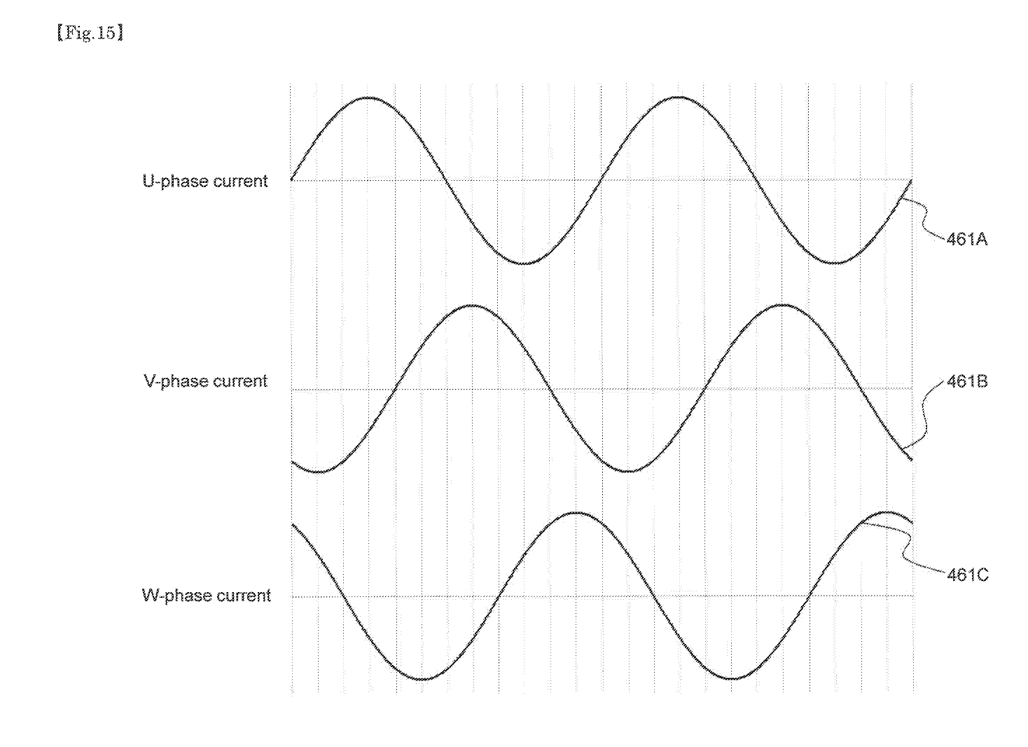

FIG. 15 shows a three-phase current supplied to three-phase coil 421. FIG. 15 shows the three-phase current 461 (i.e., 461A, 461B, 461C) when PWM (Pulse Width Modulation) control is applied to the switching circuit 450 or when the output of the power amplifier circuit is applied to the switching circuit 450. Practically, although the three-phase current includes noise, FIG. 15 shows only the components of the fundamental wave, each phase of which is shifted from the others by 120 deg. The rotor is driven at the rotational speed corresponding to the frequency of the fundamental wave.

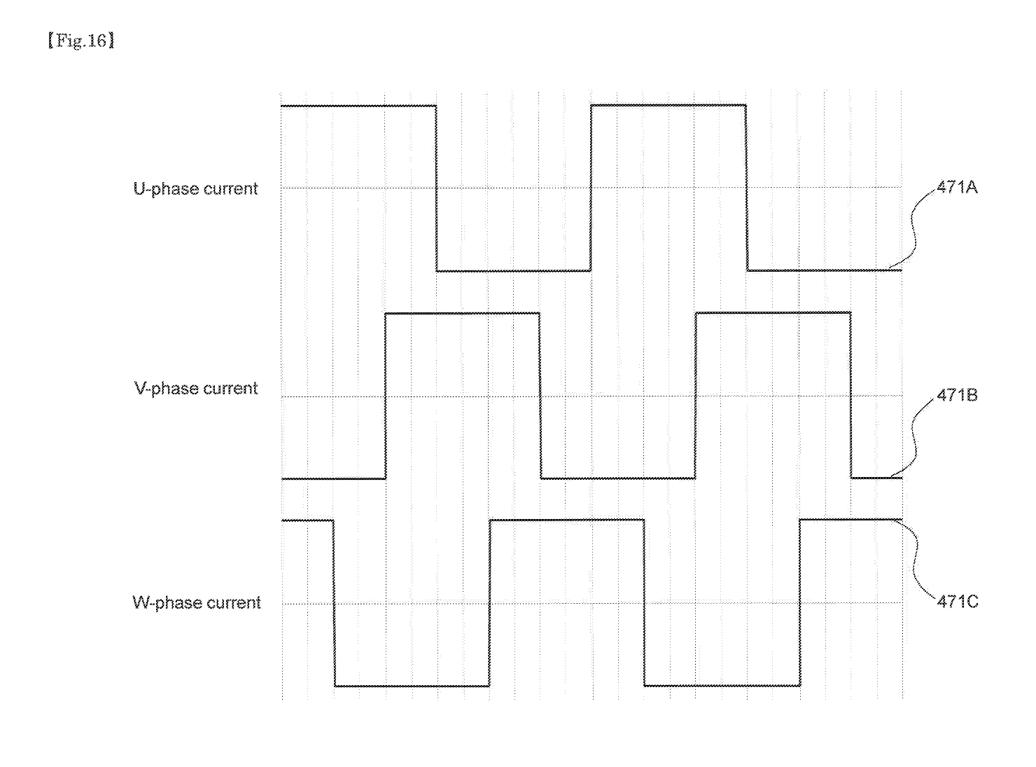

Moreover, FIG. 16 shows a three-phase current 471 (i.e., 471A, 471B, 471C) when pulse control is applied to the switching circuit 450. The three-phase currents 471 are square waves, each phase of which is shifted from the others by 120 deg.

According to the driving system 401 applied to the transverse flux machine of any of the embodiments, stable rotations of the rotor can be performed with an adequate control to the rotational position of the rotor. When the sensorless estimation is used, the sensor 431 is not needed, and cost is saved. Moreover, in the transverse flux machine, the number of phases can be optionally designed, and the transverse flux machine can be driven by PM control, or control that is the same as the control applied to PM (Permanent Magnet) motor or hybrid-stepper motor, generally.

### Fourth Embodiment

Hereinbelow, a vehicle according to a fourth embodiment will be explained. The vehicle of the fourth embodiment includes the transverse flux machine (rotary machine) of the first embodiment or the second embodiment. The vehicle described herein refers, e.g., to a two to four-wheeled hybrid electric vehicle, a two to four-wheeled electric vehicle, a motor-assisted bicycle, and the like.

A hybrid type vehicle has as a running power source a combination of an internal combustion engine and a battery-powered rotary machine. An electric vehicle has as a running power source a battery-powered rotary machine. As driving force of the vehicle, a power source having wide ranges of engine speeds and torques depending on the running conditions is necessary. Generally, the internal combustion engine is limited as to its torque and engine speed by which ideal energy efficiency can be performed, and the energy efficiency decreasing in driving conditions other than the above. In the hybrid type vehicle, the energy efficiency of the entire vehicle can be improved by the internal combustion engine at an optimal condition to generate electricity, and driving wheels with a high-efficiency rotary machine, or driving in combination by the power of the internal combustion engine and the rotary machine. Furthermore, by regenerating the kinetic energy of the vehicle upon deceleration as electric power, mileage per a unit of fuel can be dramatically increased compared to a vehicle using only the typical internal combustion engine.

The hybrid vehicle can roughly be categorized into three types depending on how the internal combustion engine and the rotary machine are combined.

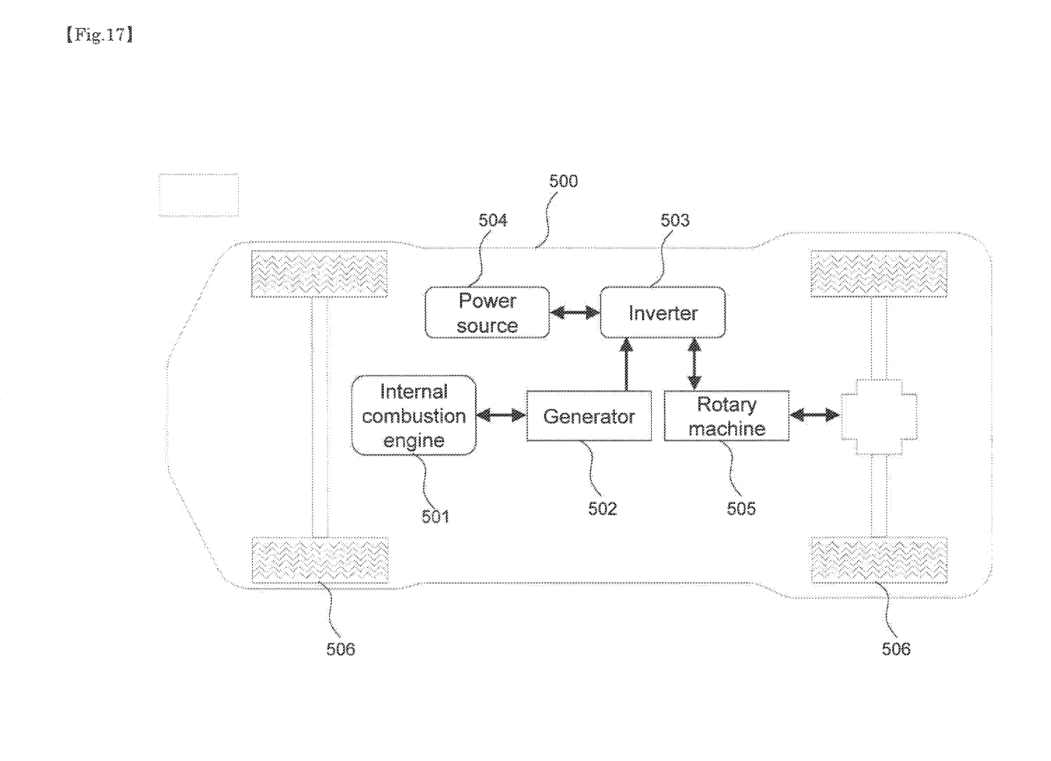

FIG. 17 shows a hybrid vehicle 500 that is generally called a series hybrid vehicle. As shown in FIG. 17, the hybrid vehicle 500 has an internal combustion engine 501, a generator 502, an inverter 503, a battery pack (power source) 504, a transverse flux machine (rotary machine) 505, and wheels 506. The rotary machine 505 is, for example, the transverse flux machine 10 according to the first embodiment (FIG. 1).

In the hybrid vehicle 500, the entirety of power of the internal combustion engine 501 is once converted into electric power by the generator 502, and this electric power charges a battery pack (power source) 504 through an inverter 503. The electric power in the battery pack 504 is supplied to the rotary machine 505 through the inverter 503, and wheels 506 are driven by the rotary machine 505. Thus, the series hybrid vehicle is a system in which the generator is incorporated into an electric vehicle. According to the hybrid vehicle 500, the internal combustion engine 501 can be driven under a high efficiency condition, and the regeneration of electric power is also possible. On the other hand, because the wheels 506 are driven by the rotary machine 505, the rotary machine 505 of high output is required.

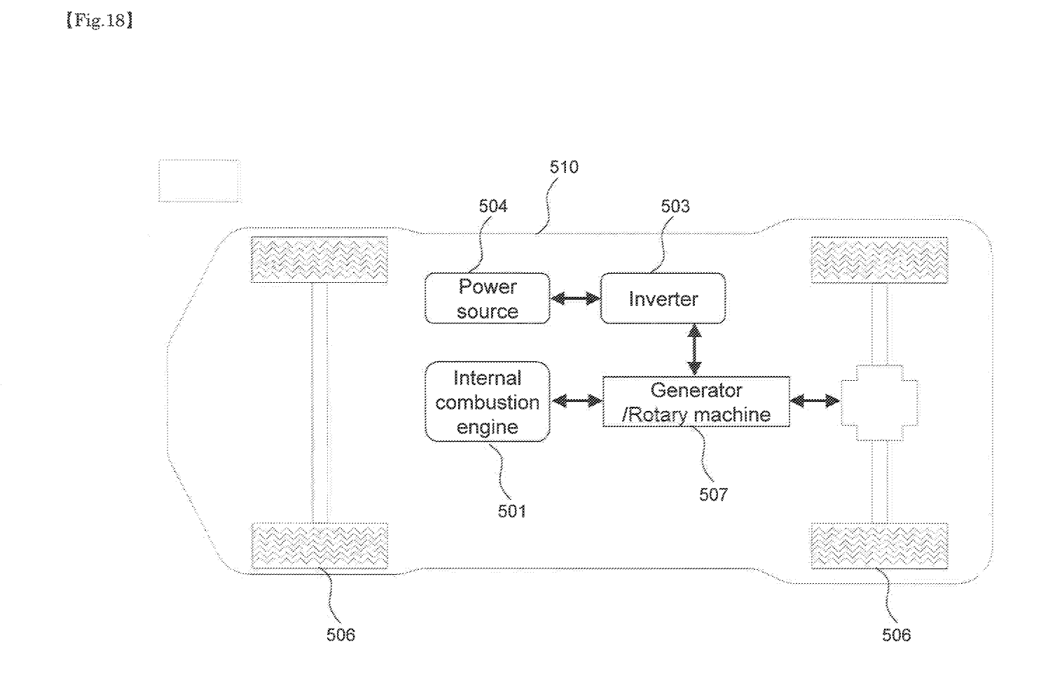

FIG. 18 shows a hybrid vehicle 510 that is called a parallel hybrid vehicle. As shown in FIG. 18, the hybrid vehicle 510 has the internal combustion engine 501, the inverter 503, the battery pack (power source) 504, a transverse flux machine (rotary machine) 507, and the wheels 506. The rotary machine 507 is, for example, the transverse flux machine 10 according to the first embodiment (FIG. 1), and the rotary machine 507 is used for driving the wheels 506 and for the generator.

In the hybrid vehicle 510, the wheels 506 are driven by the internal combustion engine 501 primarily. A part of its power is converted to electric power by the rotary machine 507 depending on the situation. The battery pack 504 is charged by the electric power through the inverter 503. The rotary machine 507 supports the driving force upon departure or acceleration, with increasing load, by supplying electric power to the rotary machine 507 from the battery pack 504 through the inverter 503. According to the hybrid vehicle 510, high-efficiency can be achieved by reducing the changes in the load of the internal combustion engine 501, and the regeneration of electric power is also possible. Moreover, since driving the wheels 506 is primarily performed by the internal combustion engine 501, the output of the rotary machine 507 can be determined optionally according to a proportion of the required support. The hybrid vehicle 510 can be configured even by using a relatively small rotary machine 507 and battery pack 504.

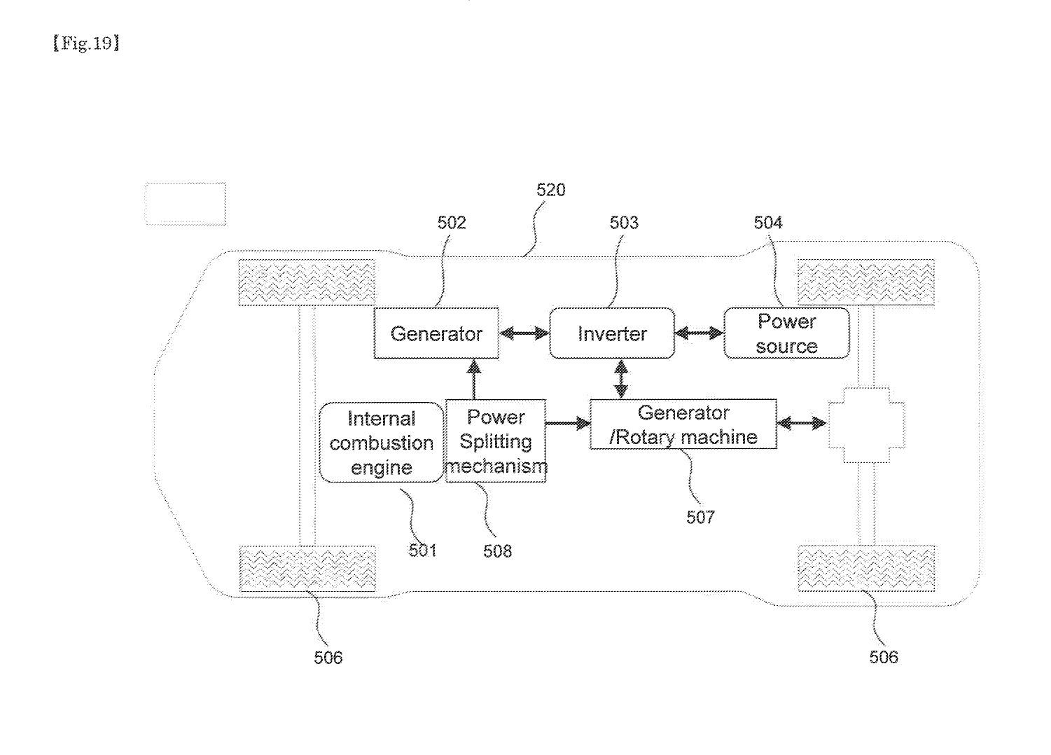

FIG. 19 shows a hybrid vehicle 520 that is called a series-parallel hybrid vehicle. It has a scheme in which both the series and the parallel are combined. A power splitting mechanism 508 splits the output of the internal combustion engine 501 for generating electricity and for driving wheels. The load control of the engine can be performed more delicately than in the parallel scheme, and energy efficiency can be increased.

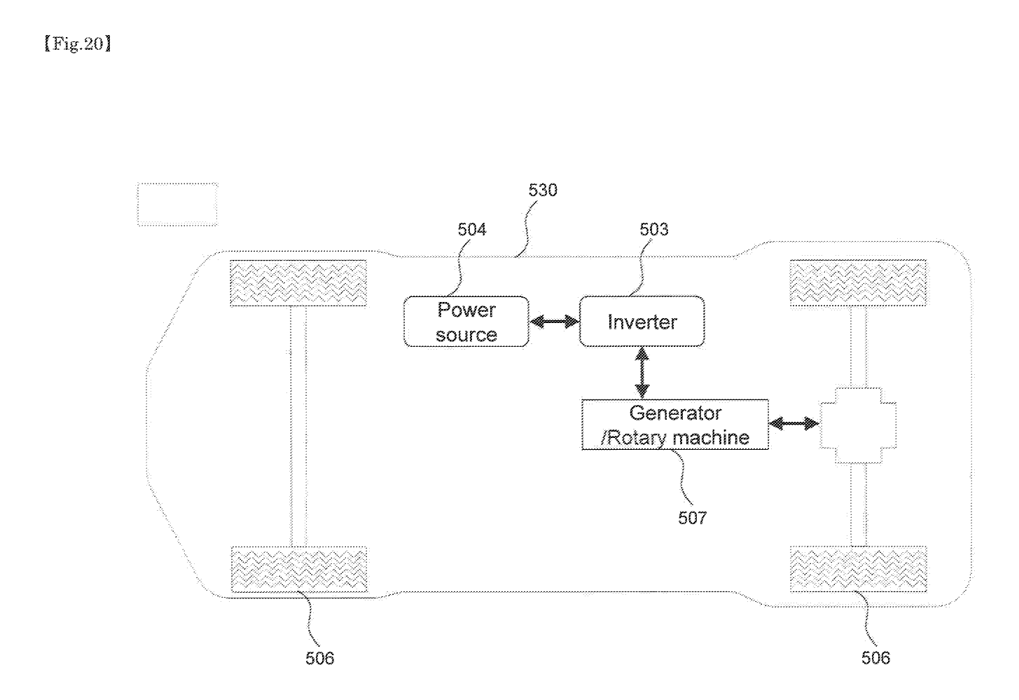

FIG. 20 shows an electric vehicle 530 according to the fourth embodiment. The rotary machine 507 is, for example, the transverse flux machine 10 according to the first embodiment (FIG. 1), and the rotary machine 507 is used for driving the wheels 506 and for the generator.

In the electric vehicle 530, the electric power in the battery pack 504 is supplied to the rotary machine 507 through the inverter 503, and wheels 506 are driven by the rotary machine 507. The rotary machine 507 drives the wheels 506, and generates the electric power as the generator depending on the situation. The battery pack 504 is charged by the generated electric power.

As described above, according to the fourth embodiment, a vehicle with a transverse flux machine according to the embodiment described above is provided.

In the transverse flux machine according to one embodiment, it is possible that the magnetic flux is short-circuited to reduce the togging torque when the current is not supplied because each flux-generation part is arranged between the adjacent rotor cores 31, and the tips of the other side of the adjacent rotor cores 31 are close to each other or are connected through the ferromagnetic material.

The transverse flux machine according to the embodiments is not limited to the example of a radial gap motor in which the normal of the surface facing the rotor and the stator is in the radial direction as shown in FIGS. 1 and 7, and an axial gap motor in which the normal of the surface facing the rotor and the stator is in the axis direction can be used. Furthermore, the transverse flux machine according to the embodiments is not limited to the example of an inner rotor in which the rotor is located on the inside of the stator as shown in FIGS. 1 and 7, and an outer rotor in which the rotor is located on the outside of the stator can be used.

These embodiments are presented merely as examples, and do not intend to limit the scope of the claims. These embodiments are capable of being carried out in various other embodiments, and various abbreviations, replacements and modification thereof can be made within a scope that does not go beyond the essence of the invention. Further, these embodiments and modifications thereof are included in the scope and essence of the invention, and at the same time, are included in the invention described in the claims and a scope of equivalents thereof.

What is claimed is:

1. A transverse flux machine comprising:
a stator having a circular coil wound in a rotational direction, a plurality of first ferromagnets arranged in the rotational direction, each of the first ferromagnets surrounding a part of the circular coil; and
a rotor arranged to face the first ferromagnets across a gap, the rotor being rotatable about a center axis of the circular coil;
wherein the rotor includes
a plurality of second ferromagnets arranged in the rotational direction; and
a flux-generation part arranged between the adjacent second ferromagnets, each of the second ferromagnets to generate a magnetic field in the rotational direction.

2. The transverse flux machine according to claim 1,
wherein the plurality of second ferromagnets includes a first member, a second member and a third member in the rotational direction,
wherein the flux-generation part includes a first flux-generation part arranged between the first member and the second member, and a second flux-generation part arranged between the second member and the third member, the first flux-generation part and the second flux-generation part to generate the magnetic field opposite to each other in the rotational direction.

3. The transverse flux machine according to claim 1, further comprising:
a third ferromagnet arranged between the adjacent second ferromagnets.

4. The transverse flux machine according to claim 1,
wherein any of the first ferromagnets and the second ferromagnets has an anisotropy characteristic in part.

5. A transverse flux machine comprising:
a plurality of stators, each having a circular coil wound in a rotational direction, a plurality of first ferromagnets arranged in the rotational direction, each of the first ferromagnets surrounding a part of the circular coil; and
a plurality of rotors, each arranged to face ones of the first ferromagnets across a gap, the rotor being rotatable about a center axis of the circular coil relatively to a corresponding one of the stators;
wherein each of the rotors includes
a plurality of second ferromagnets arranged in the rotational direction; and
a flux-generation part arranged between the adjacent second ferromagnets, each of the second ferromagnets to generate a magnetic field in the rotational direction,
wherein each relative phase of the stator and the rotor in the rotational direction differs.

6. The transverse flux machine according to claim 1, further comprising:
a detector to detect a rotational position of the rotor, and generate position data;
a controlling unit configured to obtain the position data and to control an amount of current to the circular coil based on the position data.

7. A vehicle comprising:
the transverse flux machine according to claim 1 or claim 5.

8. The vehicle according to claim 7,
wherein the transverse flux machine further comprises:
a detector to detect a rotational position of the rotor, and to generate position data; and
a controlling unit configured to obtain the position data and to control an amount of current to the circular coil based on the position data.

9. The vehicle according to claim 8, further comprising:
a power source to output an electric power; and
an inverter to convert the electric power;
wherein the transverse flux machine is operated by the electric power converted by the inverter.
